(19) United States
(12) Patent Application Publication
(10) Pub. No.: US 2014/0343493 A1
(43) Pub. Date: Nov. 20, 2014

(54) STORAGE DEVICES AND STORAGE METHODS FOR INJECTABLE SUBSTANCES

(71) Applicant: Sandy Wengreen, Sammamish, WA (US)

(72) Inventor: Sandy Wengreen, Sammamish, WA (US)

(21) Appl. No.: 13/896,211

(22) Filed: May 16, 2013

(51) Int. Cl. A61J 1/16; B65D 81/38

(52) U.S. Cl. CPC A61J 1/165; B65D 81/38
USPC 604/114; 220/592.2; 53/471

(57) ABSTRACT

Devices to store injectable substances can include a chamber configured to store an injectable substance, a thermal bank, and an insulated cover. In some embodiments, the thermal bank is located inside of the insulated cover and at least a portion of the chamber is located inside of the thermal bank.

### BACKGROUND

1. Field

Various embodiments disclosed herein relate to devices and methods to store medicinal drugs. Certain embodiments relate to storing injectable substances at a suitable temperature.

2. Description of Related Art

Users of injectable substances, such as epinephrine, adrenaline, and insulin, are faced with a difficult challenge. On one hand, physicians often advise them to take an injectable substance with them wherever they go, yet on the other hand, the temperature of the injectable substance often should be maintained within a temperature range that is incompatible with outdoor temperatures. For example, a certain injectable substance might need to be stored within a temperature range of 65 degrees Fahrenheit to 85 degrees Fahrenheit. Outdoor temperatures are often colder than 65 degrees Fahrenheit or warmer than 85 degrees Fahrenheit. As a result, patients who need injectable substances sometimes must remain indoors, risk going outdoors without the safety of carrying the injectable substance, or risk reducing the efficacy of the injectable substance by carrying it into environments with temperatures outside of the recommended range.

Prior art solutions have included refrigerators to store injectable substances within a suitable range. (The suitable range can be the storage range recommended by the manufacturer of the injectable substance.) Refrigerators require substantial electrical power. Constantly having to plug a refrigerator into a power supply, changing batteries, or recharging batteries is inconvenient. In addition, users sometimes forget to provide adequate power, which can result in harming the injectable substance, and thereby, creating a health risk to the user. Thus, there is a need for devices and methods to store injectable substances within a suitable temperature range while requiring less electrical power.

### SUMMARY

In some embodiments, devices to store injectable substances can include a chamber configured to store an injectable substance, a thermal bank, and an insulated cover. In some embodiments, the thermal bank is located inside of the insulated cover and at least a portion of the chamber is located inside of the thermal bank.

In some embodiments, devices to store injectable substances can include an outer case and a vacuum flask located inside the outer case. The devices can include a thermal bank located inside the vacuum flask. The thermal bank can include a void that extends from an inner portion of the thermal bank to an outer portion of the thermal bank. An injectable substance can be located inside the void. The devices can include a removable lid configured to allow a user to remove the injectable substance from the storage device. In some embodiments, a user unthreads or rotates the lid to remove the lid.

Several embodiments include methods of storing injectable substances, inhalers, pharmaceuticals, or drugs. Some method embodiments comprise obtaining an outer case and a lid. Several methods include placing a vacuum flask inside the outer case and placing a thermal bank inside the vacuum flask. Some methods include placing an injectable substance inside the vacuum flask and closing the lid such that the outer case and the lid completely surround the injectable substance.

### BRIEF DESCRIPTION OF THE DRAWINGS

These and other features, aspects, and advantages are described below with reference to the drawings, which are intended to illustrate but not to limit the invention. In the drawings, like reference characters denote corresponding features consistently throughout similar embodiments.

FIG. 1 illustrates a side view of a storage device, according to one embodiment.

FIG. 2 illustrates a cross sectional view of a storage device embodiment along plane A-A, which extends into the page in FIG. 1.

FIG. 3 illustrates the same cross section as illustrated in FIG. 2 except that items omitted from FIG. 2 to increase the clarity of FIG. 2 are visible in FIG. 3.

FIG. 4 illustrates a cross sectional view wherein an injectable substance is located inside a chamber, according to one embodiment.

FIG. 5 illustrates a cross sectional view of another embodiment of a storage device.

FIG. 6 illustrates thicknesses of a thermal bank, according to several embodiments.

FIG. 7 illustrates a cross sectional view of another embodiment of a storage device.

FIG. 8 illustrates a perspective view of a thermal bank, according to several embodiments.

FIG. 9 illustrates a cross sectional view of an embodiment with an inhaler located inside of a storage device, according to one embodiment.

### DETAILED DESCRIPTION

Several embodiments of a storage device for injectable substances include a thermally insulating container. A substance with a high heat capacity can be located inside the insulating container. The substance can have a specific heat capacity of at least 2 Joules/gram*Kelvin and/or a volumetric heat capacity of at least 2 Joules/cm³*Kelvin. A chamber configured to hold an injectable substance can also be located inside the insulating container. In some embodiments, the substance with a high heat capacity at least partially surrounds at least a portion of the chamber configured to hold the injectable substance.

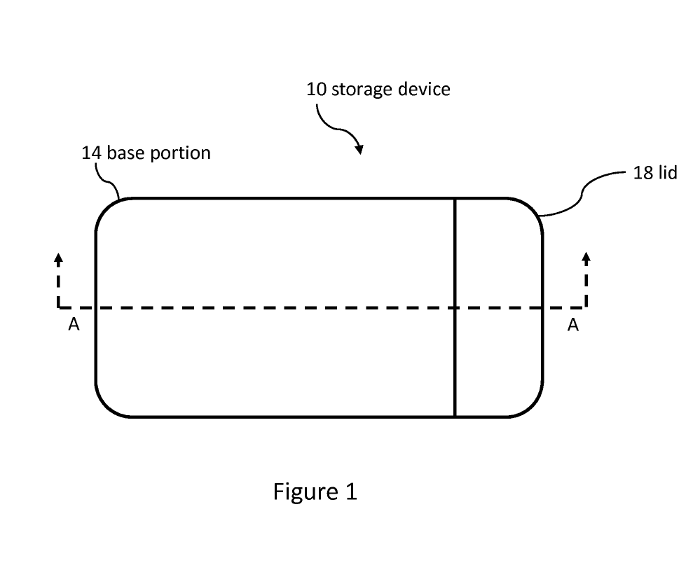

FIG. 1 illustrates an embodiment of a storage device 10. The storage device 10 can have a base portion 14 and a lid 18. The storage device 10 can be configured to store injectable substances such as epinephrine, adrenaline, and/or insulin such that the temperature of the injectable substances is maintained within a suitable temperature range, which can be approximately room temperature or 75+/−10 degrees Fahrenheit, 75+/−15 degrees Fahrenheit, or 75+/−20 degrees Fahrenheit, according to several embodiments.

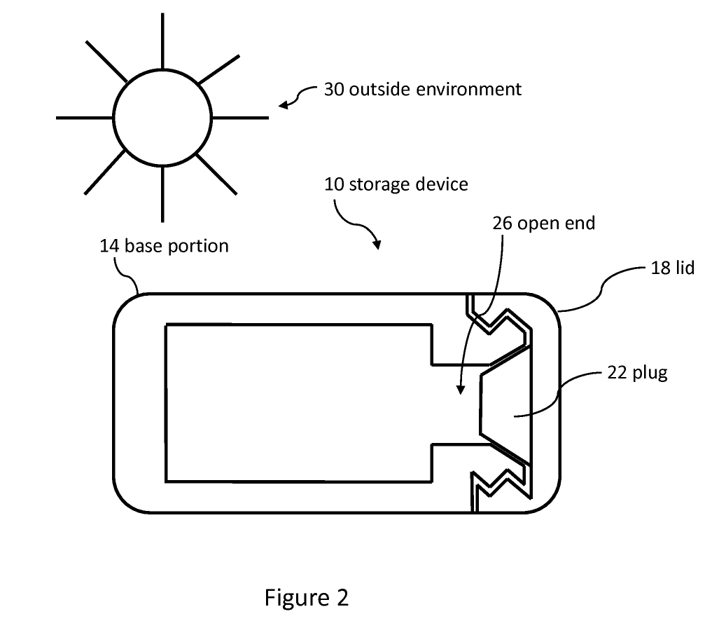

FIG. 2 illustrates a cross section of the storage device 10 along plane A-A, which extends into the page in FIG. 1. The lid 18 is coupled to the base portion 18 by threads such that the lid 18 can be twisted onto the base portion 14 to couple the lid 18 to the base portion 14. A plug 22 can seal and/or insulate an open end 26 of the base portion 14. Coupling the lid 18 to the base portion 14 can push the plug 22 towards the base portion 14 to seal and/or insulate an internal portion of the storage device 10 from the outside environment 30, which is represented in FIG. 2 as the sun. The outside environment 30 is the environment outside of the storage device 10. For example, the outside environment 30 could be a cold, snowy day or a hot, dry day.

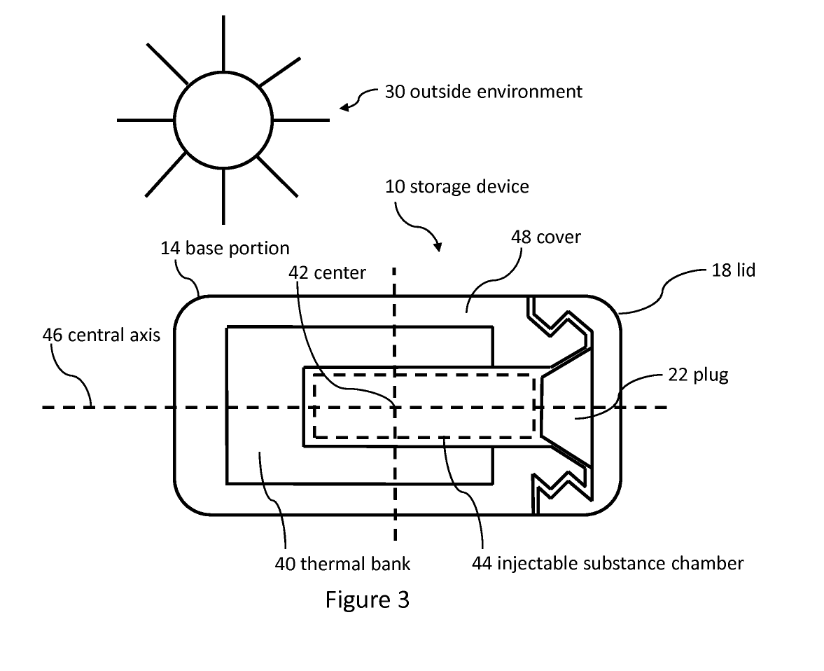

FIG. 3 illustrates the same cross section as illustrated in FIG. 2 except that items omitted from FIG. 2 to increase the clarity of FIG. 2 are visible in FIG. 3. In some embodiments, the storage device 10 includes a thermal bank 40 that is located inside a cover 48 that insulates the thermal bank 40 from the outside environment 30. The cover 48 is configured to insulate the thermal bank 40. The cover 48 can include a vacuum chamber, a vacuum flask, foam, and/or plastic walls separated by air. In some embodiments, the cover 48 is an insulated cover. The lid 18 can also include one or more insulators such as foam, a vacuum chamber, and plastic walls separated by air.

A “thermal bank” is a component or assembly that has a heat capacity of at least 400 J/K. In several embodiments, thermal banks have a heat capacity that is large enough to maintain the temperature of an injectable substance chamber 44 within an acceptable temperature range for an acceptable period of time. Acceptable temperature ranges and acceptable periods of time vary widely by application and design purpose. In some embodiments, thermal banks are at least partially filled with a liquid or a solid selected to provide sufficient heat capacity. In some embodiments, thermal banks have outer walls made of metal, glass, or plastic and are filled with a substance with sufficiently high heat capacity. In some embodiments, the substance with sufficiently high heat capacity is a solid at 75 degrees Fahrenheit, so outer walls are sometimes not included in thermal banks. For example, some thermal bank embodiments are sleeves of wax or metal.

Herein, Joule is often abbreviated as J, kelvin is often abbreviated as K, gram is often abbreviated as g, cubic centimeter is often abbreviated as cm3, and Fahrenheit is often abbreviated as F. In some embodiments, the thermal bank 40 has a heat capacity of at least 400 J/K; at least 700 J/K; at least 1,400 J/K; at least 2,400 J/K; at least 3,200 J/K; at least 4,800 J/K; at least 7,200 J/K; at least 20,000 J/K; less than 7,200 J/K; and/or less than 30,000 J/K.

In some embodiments, the thermal bank 40 comprises a substance that has a specific heat capacity of at least 1 J/g.K at 75 degrees F., at least 2 J/g.K at 75 degrees F., at least 3 J/g.K at 75 degrees F., or at least 4 J/g.K at 75 degrees F. In some embodiments, the thermal bank 40 comprises a substance with a volumetric heat capacity of at least 1 J/cm3.K at 75 degrees F., at least 2 J/cm3.K at 75 degrees F., at least 3 J/cm3.K at 75 degrees F., or at least 4 J/cm3.K at 75 degrees F.

In several embodiments, a thermal bank and/or a substance with any of the heat capacities described herein has a volume of at least 50 cm3 and/or less than 2,000 cm3; at least 100 cm3 and/or less than 1,000 cm3; at least 200 cm3 and/or less than 500 cm3. In some embodiments, the thermal bank is a reservoir or container filled with a fluid such as water. The reservoir or container can be made of plastic and can be a shell wherein an inner portion of the shell can be at least partially filled with a liquid. The center of the reservoir or container can include a channel or void that is fluidly isolated from the liquid inside the container. The channel or void can be configured to hold or store an injectable substance or an injection device. In some embodiments, the thermal bank has a generally cylindrical shape and/or a cylindrical channel or cylindrical void.

In some embodiments, the thermal bank 40 comprises ammonia, lithium, water, wax, and/or metal. In some embodiments, the thermal bank 40 comprises iron, copper, zinc, tungsten, aluminum, paraffin wax, lithium, granite, and/or magnesium. In some embodiments, the thermal bank 40 is a chamber that is at least 40%, at least 60%, or at least 80% filled with a solid and/or liquid such as ammonia, lithium, water, wax, and/or metal.

In several embodiments, a chamber 44 configured to hold an injectable substance is located inside the storage device 10. The injectable substance chamber 44 can be located approximately along the central axis 46 of the storage device 10. In FIG. 3, the injectable substance chamber 44 is highlighted by a dashed rectangle. The injectable substance chamber 44 can be a hole, void, or open area. The injectable substance chamber 44 can include portions of the central axis 46. The injectable substance chamber 44 can include the volumetric center 42 of the storage device 10. A least a portion of the injectable substance chamber 44 can be at least partially surrounded by the thermal bank 40. In some embodiments, the injectable substance chamber 44 is located inside a portion of the thermal bank 40. In several embodiments, at least 40%, at least 60%, or at least 80% of the volume of the injectable substance chamber 44 is located inside the thermal bank 40. As illustrated in FIG. 3, a portion of the injectable substance chamber 44 can be located inside the thermal bank 40 even if the thermal bank 40 does not completely surround the injectable substance chamber 44.

The injectable substance chamber 44 can be configured to hold an injectable substance, which may be packaged in a separate storage container such as a plastic vial, a glass jar, and/or an injection device such as a syringe. Example injectable substances can be contained in products such as EpiPens, Twinjects, Adrenaclicks, Anapens, Jexts, Allerjects, Auvi-Qs, and ComboPens. Some injectable substance chambers 44 are configured to hold multiple containers of injectable substances. Some injectable substance chambers 44 are configured to hold an inhaler and/or another drug container.

As used herein, the term injectable substance can include a container that holds a liquid that users inject into their bodies. Some embodiments are similar to other embodiments described herein except that the injectable substance is replaced with a container of an injectable liquid. The container can be plastic, glass, and/or a syringe.

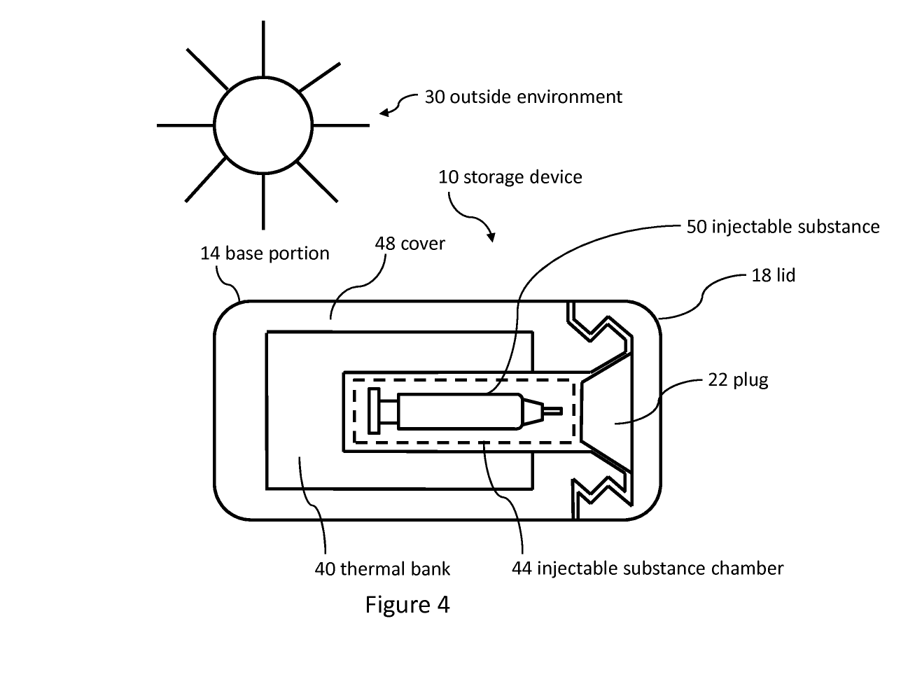

FIG. 4 illustrates an injectable substance 50 located inside the injectable substance chamber 44. In several embodiments, the injectable substance chamber 44 is isolated from liquids located inside the storage device 10 such that the storage device 10 is configured to keep the injectable substance 50 dry and/or away from liquids. In some embodiments, the storage device 10 does not include any liquids although some embodiments include a liquid, such as water, inside the thermal bank 40.

The injectable substance 50 can include epinephrine, adrenaline, insulin, hormones, and/or neurotransmitters. The injectable substance 50 can include liquids or gases used to treat acute allergic reactions, to avoid anaphylactic shock, and/or to treat anaphylactic shock. The injectable substance 50 can include liquids or gases used to treat diabetes. In some embodiments, the injectable substance 50 is an epinephrine auto-injector such as the EpiPen or EpiPen Jr. made by Mylan Specialty L.P. In some embodiments, the injectable substance is replaced by another pharmaceutical product or by another product that benefits from temperature stability.

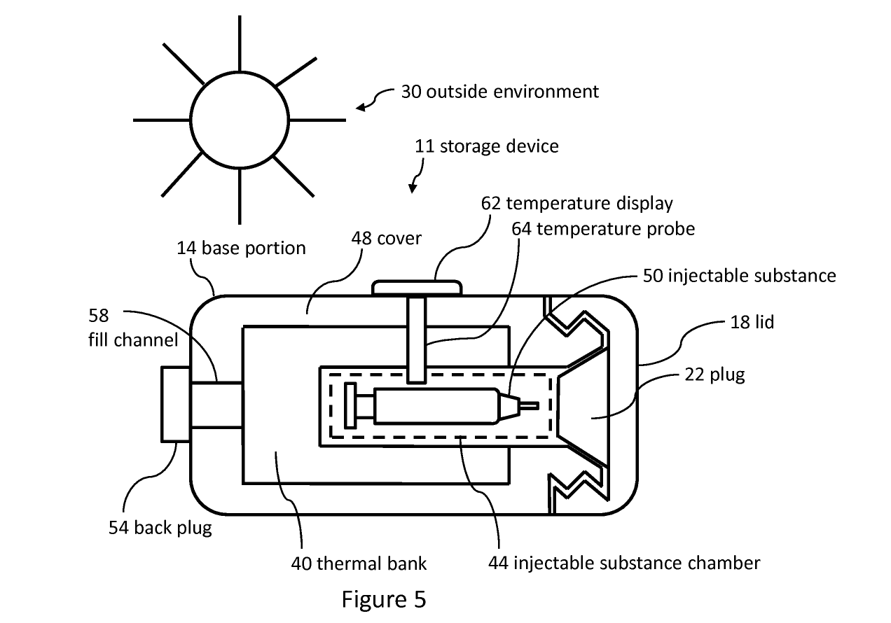

FIG. 5 illustrates another embodiment of a storage device 11. The storage device 11 includes a back plug 54, which can be a removable plug made of rubber that threads into the base portion 14 or uses a friction fit (or interference fit) with an opening in the base portion 14. Removing the back plug 54 can expose a fill channel 58 that is configured to allow a substance with sufficient heat capacity to go into the thermal bank 40. For example, a user or a manufacturer could open the back plug 54 and pour a liquid such as water into the thermal bank 40. In some embodiments, a user can pour water with a temperature that is lower than the suitable range if the user intends to enter an outside environment 30 with a temperature that is higher than the suitable range. In some embodiments, a user can pour water with a temperature that is higher than the suitable range if the user intends to enter an outside environment 30 with a temperature that is lower than the suitable range.

Some embodiments include a thermometer, which can include a temperature probe 64. At least a portion of the temperature probe 64 can be located inside the injectable substance chamber 44 such that the temperature probe 64 is configured to measure, evaluate, test, and/or determine the temperature inside the injectable substance chamber 44 and/or the temperature of the injectable substance 50. The thermometer can also include a temperature display 62, which can be located outside of the cover 48 such that the temperature display 62 is configured such that a user can read and/or determine the temperature on the display 62 without opening the lid 18.

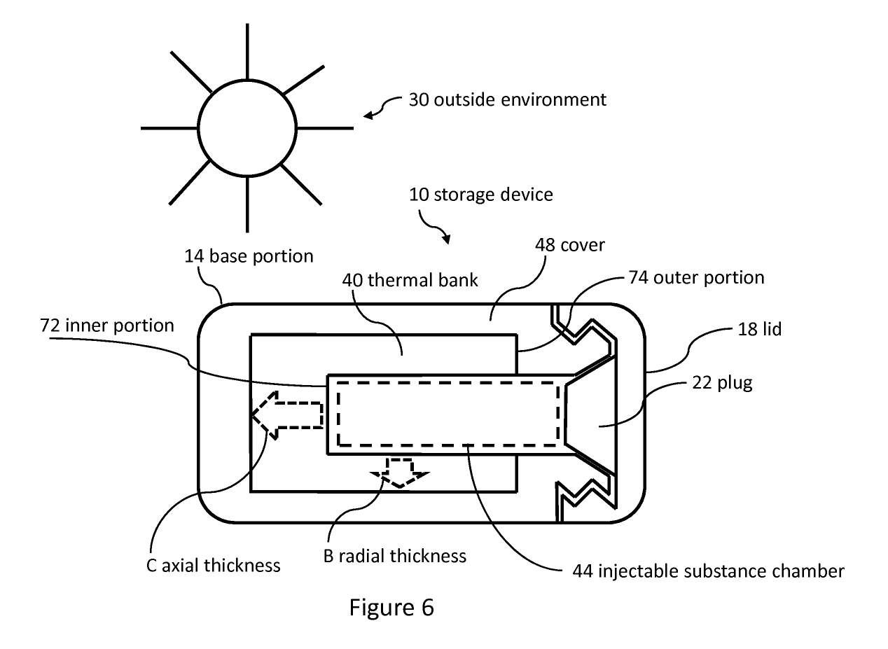

FIG. 6 illustrates thicknesses of the thermal bank 40, according to several embodiments. In some embodiments, the radial thickness (as illustrated by dashed arrow B) of the thermal bank 40 is at least 3 mm and/or less than 100 mm; at least 7 mm and/or less than 200 mm; or at least 20 mm and/or less than 200 mm. In some embodiments, the axial thickness (as illustrated by dashed arrow B) of the thermal bank 40 is at least 10 mm and/or less than 100 mm; at least 20 mm and/or less than 200 mm; or at least 40 mm and/or less than 200 mm.

Some embodiments include an insulated container configured to maintain injectable substances at approximately room temperature. In several embodiments, the insulated container can include a chamber configured to hold an injectable substance. The chamber can be surrounded by a substance with high heat capacity. The substance with high heat capacity can be surrounded by an insulated cover.

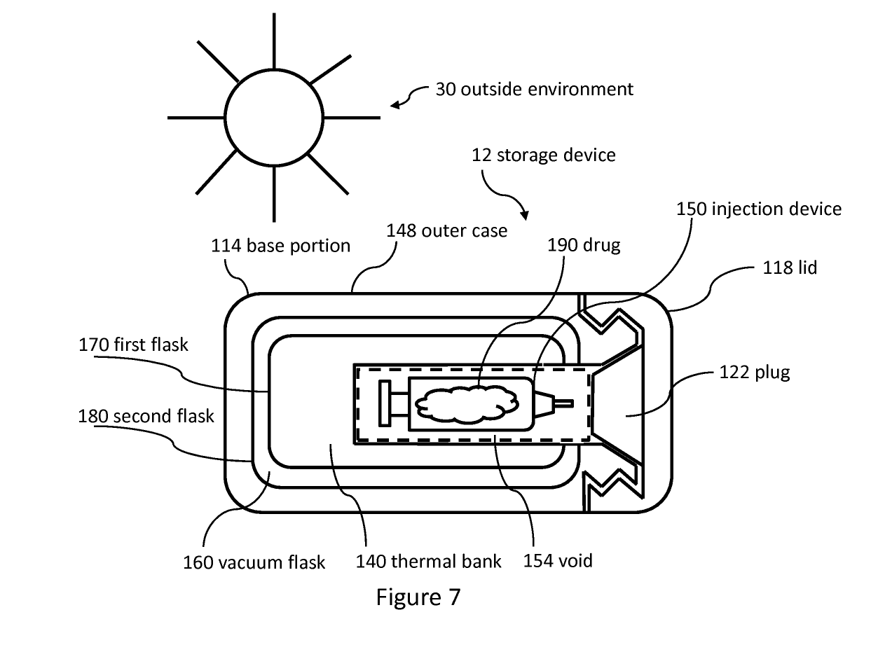

FIG. 7 illustrates another embodiment of a storage device 12. The storage device 12 can include an outer case 148, which can be made of plastic or metal. The storage device can include a vacuum chamber such as a vacuum flask 160. The vacuum flask 160 can be located inside the outer case 148 such that the outer case 148 can be configured to protect the vacuum flask 160 from damage such as cracking. The vacuum flask 160 can comprise an inner wall and an outer wall with a gas pressure between the inner wall and the outer wall that is less than atmospheric pressure. In some embodiments, the pressure between the inner wall and the outer wall can be less than 60% of atmospheric pressure, less than 40% of atmospheric pressure, or less than 20% of atmospheric pressure. The atmospheric pressure can be measured at sea level. The vacuum flask 160 can include a first flask 170 placed inside a second flask 180. The first flask 170 and the second flask 180 can be joined at the neck such that the area between the first flask 170 and the second flask 180 is hermetically sealed from the air outside of the area between the first flask 170 and the second flask 180. The vacuum flask 160 can be made of glass, metal, foam, or plastic.

A thermal bank 140 can be located inside the vacuum flask 160. In some embodiments, the thermal bank 140 comprises a heat capacity of at least 4,800 J/K. The thermal bank 140 can comprise a void 154 that extends from an inner portion of the thermal bank to an outer portion of the thermal bank. In some embodiments, the void is at least 1 cm wide and/or less than 10 cm wide; or at least 2 cm wide and/or less than 20 cm wide. The void 154 can be an injectable substance chamber. In FIG. 7, a dashed rectangle is used to highlight the void 154.

In several embodiments, the void 154 is configured to store, hold, and/or contain an injectable substance 50, an injection device 150, a liquid manufactured to inject into a human body, and/or a syringe. In some embodiments, an injectable substance 50, an injection device 150, epinephrine, adrenaline, insulin, and/or a syringe is located inside the void. A removable lid 118 can be configured to allow a user to remove the injectable substance 50, the injection device 150, epinephrine, adrenaline, insulin, and/or a syringe from the storage device. The removable lid 118 can press a rubber plug 122 onto an end of the vacuum flask 160 and/or onto a base portion 114.

Various embodiments are similar to other embodiments described herein except that the injectable substance 50 is replaced with an injection device 150 that is at least partially filled with a pharmaceutical agent, epinephrine, adrenaline, insulin, a liquid manufactured for injection into a human body, and/or a liquid. FIG. 7 illustrates an injection device 150. An injection device 150 can be a syringe. In some embodiments, the injection device 150 is an EpiPen, a syringe with epinephrine, a syringe with insulin, a syringe with adrenaline, an auto-injector configured to deliver a liquid under the skin of a human or animal, and/or a device configured to deliver a drug under the skin of a human or animal. In some embodiments, the injection device 150 comprises a reservoir at least partially filled with a liquid. The injection device 150 can also comprise an orifice that is configured to deliver the liquid under the skin. The injection device 150 can also comprise a needle, a nozzle, and/or a tube configured to deliver a liquid and/or pharmaceutical substance under the skin.

Various embodiments are similar to other embodiments described herein except that the injectable substance is replaced with a pharmaceutical, a pharmaceutical agent, a pharmaceutical substance, an inhaler, and/or a medical device. In some embodiments, the pharmaceutical agent and/or pharmaceutical substance is a medicinal drug 190, which can be a gas, liquid, or solid. For example, the drug 190 can be a medication contained in an inhaler for the treatment of asthma. In some embodiments, the drug 190 is a steroid, such as Flovent or fluticasone propionate, that reduces the release of substances in the body that cause inflammation to prevent asthma attacks.

FIG. 7 illustrates an embodiment with an outer case 148 and a lid 118. A vacuum flask 160 was placed inside the outer case 148. A thermal bank 140 was placed inside the vacuum flask 160. An injectable substance was placed inside the vacuum flask 160. The lid 118 was closed such that the outer case 148 and the lid 118 completely surround the injectable substance. The outer case 148 can be an insulated cover and/or can include insulation.

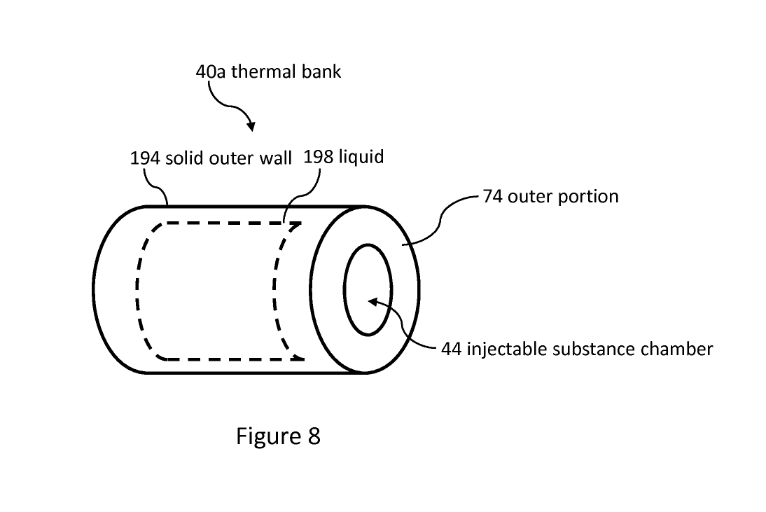

FIG. 8 illustrates a perspective view of a thermal bank 40a with an injectable substance chamber 44 or void. The thermal bank 40a can be a container with solid outer walls 194 and can be at least partially filled with a liquid 198.

The thermal bank 40a can be located or placed inside a vacuum flask or vacuum chamber. The thermal bank 40a can comprise any of the heat capacities, specific heat capacities, volumetric heat capacities, and/or heat capacity characteristics described herein. The thermal bank 40a can comprise an injectable substance chamber 44 or void that extends from an inner portion 72 of the thermal bank 40a to an outer portion 74 of the thermal bank 40a (as illustrated in FIG. 6), wherein the injectable substance chamber 44 or void is at least 1 cm wide and 4 cm long. In some embodiments, an injectable substance, an injection device, a drug, a pharmaceutical agent, a pharmaceutical substance, and/or an inhaler is located inside the injectable substance chamber 44 or void. In FIG. 8, the injectable substance chamber 44 is a void. The thermal bank 40a can be substantially cylindrical. The injectable substance chamber 44 or void can be substantially cylindrical.

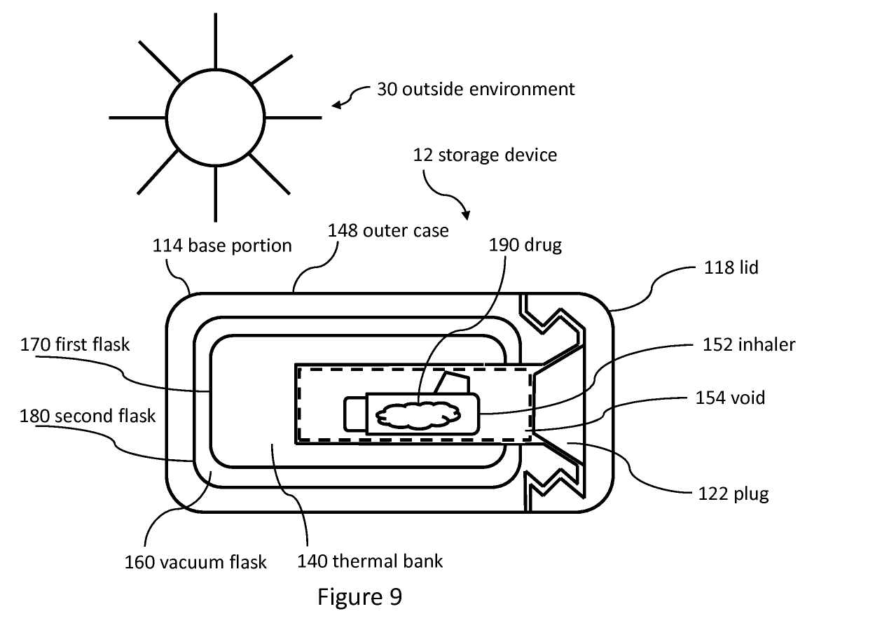

FIG. 9 illustrates an embodiment with an inhaler 152 located, placed, and positioned inside the void 154. An inhaler or puffer is a medical device typically used for delivering medicine into the body via the lungs. Inhalers are commonly used to treat asthma and chronic obstructive pulmonary disease.

In some embodiments, storage devices do not use battery power and/or electricity. While some embodiments use electrical power, several embodiments do not use electrical power and/or do not use electrical power to control or alter the temperature inside the storage device 12. For example, the embodiment in FIG. 9 does not use electrical power.

In some embodiments, storage devices are substantially cylindrical. For example, the storage device 12 in FIG. 9 is substantially cylindrical.

Some methods of storing an injectable substance include obtaining a storage device configured to store an injectable substance, wherein the storage device comprises a thermal bank located inside an insulated cover. Several methods include maintaining the thermal bank in a first environment with a temperature of at least 60 degrees F. and placing an injectable substance inside the storage device while the thermal bank has a temperature of at least 60 degrees F. Some methods include moving the storage device with the injectable substance located inside to a second environment with a temperature of less than 60 degrees F. and moving the storage device to a third environment with a temperature of more than 60 degrees before the temperature of the thermal bank is less than 60 degrees F. Some embodiments are similar to the above embodiment except that 60 degrees F. is replaced with 65 degrees F., 55 degrees F., or 50 degrees F.

Several methods include maintaining the thermal bank in a first environment with a temperature of at least 60 degrees F. and less than 85 degrees F. and placing an injectable substance inside the storage device while the thermal bank has a temperature of at least 60 degrees F. and less than 85 degrees F. Some methods include maintaining the thermal bank in a first environment with a temperature of at least 65 degrees F. and less than 80 degrees F. and placing an injectable substance inside the storage device while the thermal bank has a temperature of at least 65 degrees F. and less than 80 degrees F.

Several method embodiments include obtaining a storage device with an internal chamber such as an injectable substance chamber wherein the internal chamber has a temperature and the storage device is configured not to use electricity, electrical power, or batteries to alter the temperature of the internal chamber. In some embodiments, the storage device is configured not to use electricity, electrical power, electrical power cords, or batteries. Some method embodiments include placing or maintaining the storage device in a first environment, which has a temperature within a first temperature range, for a first period of time. In some embodiments, the first environment can be indoors, approximately 77 degrees F., approximately 74 degrees F., approximately room temperature, and/or another temperature or temperature range listed herein. In some embodiments, The first temperature range can be approximately room temperature; at least 70 degrees F. and/or less than 80 degrees F.; at least 65 degrees F. and/or less than 85 degrees F.; equal to or greater than about 59 degrees F. and/or less than or equal to 86 degrees F.; or at least 55 degrees F. and/or less than or equal to 90 degrees F. The first period of time can be the time necessary for the temperature of the storage device, thermal bank, and/or internal chamber to reach a temperature that is within any one of the ranges listed above and/or within the first temperature range. Some method embodiments include placing or maintaining the storage device in the first environment until heat transfer between the first environment and the storage device causes the temperature of the storage device to be within any one of the ranges listed above and/or within the first temperature range.

Some method embodiments include placing a medicinal drug, an injectable substance, an injection device, an inhaler, and/or a pharmaceutical substance inside the storage device while the storage device has a temperature within any one of the ranges listed above and/or within the first temperature range. The temperature of the storage device can be defined by the temperature of the thermal bank, the weighted average temperature of the storage device (where the temperature of each material is weighted by the heat capacity of the material), or any other suitable method.

Several method embodiments include closing a lid of the storage device while the storage device is located in the first environment with the first temperature such that the storage device surrounds the medicinal drug, injectable substance, injection device, inhaler, and/or pharmaceutical substance located inside the storage device.

Some method embodiments include removing the storage device from the first environment and transporting the storage device towards a second environment while the storage device has a temperature within the first temperature range. In other words, in some embodiments, the storage device does not have cold packs (such as ice) or heat packs (such as chemical hand warmers) located inside of the storage device. For example, in some embodiments, the storage device can have a weighted average temperature of approximately room temperature when the storage device is removed from the first environment and transported towards the second environment.

Several method embodiments include moving the storage device to a second environment with a second temperature range for a second period of time. In some embodiments, the second temperature range comprises all temperatures except for the temperatures within the first temperature range. In some embodiments, the second temperature range is less than the first temperature range and/or greater than the first temperature range. In some embodiments, the second temperature range is less than room temperature and/or greater than room temperature; less than 70 degrees F. and/or greater than 80 degrees F.; less than 65 degrees F. and/or greater than 85 degrees F.; less than 59 degrees F. and/or greater than 86 degrees F.; less than 55 degrees F. and/or greater than 90 degrees F.; or less than 32 degrees F. and/or greater than 100 degrees F.

The second period of time can be a time during which the temperature of the internal chamber stays within the first temperature range. Some method embodiments include maintaining the storage device in the second environment while the temperature of the internal chamber stays within the first temperature range. Some method embodiments include moving the storage device from the second environment to a third environment before the temperature of the internal chamber deviates outside of the first temperature range. Some method embodiments include moving the storage device from the second environment to the third environment before the temperature of the internal chamber changes to a temperature outside of the first temperature range. Is some embodiments, the temperature of the third environment is equal to any of the temperatures and/or temperature ranges described above for the first environment. The temperature of the third environment can be different than the temperature of the first environment. In some embodiments, the third environment is the first environment such that the storage device is moved from the first environment to the second environment and then back to the first environment. Some embodiments include removing and/or at least partially opening the lid after the storage device is returned to the first environment and/or moved to the third environment.

Some embodiments include maintaining the storage device at approximately room temperature, placing a substance inside of the storage device, moving the storage device to an environment that is hotter or colder than room temperature while the storage device has an internal temperature of approximately room temperature and/or a temperature within a suitable range, and then returning the storage device to approximately room temperature before the internal temperature deviates outside of a suitable range. The suitable range can be the storage temperature range recommended by the manufacturer of the substance and/or a temperature range recommended and/or approved by the manufacturer of the substance for temporary temperature excursions. Some embodiments include returning the storage device to approximately room temperature before the recommended and/or approved time of the temporary temperature excursion expires.

Several embodiments of a method of storing a medicinal injectable substance include obtaining an outer case and a lid. Some embodiments include placing a vacuum flask inside at least a portion of the outer case. Placing a vacuum flask inside at least a portion of the outer case can include placing an outer case around at least a portion of a vacuum flask. Some embodiments include placing a thermal bank with a heat capacity of at least 400 J/K inside the vacuum flask. Several embodiments include placing an injection device inside the vacuum flask, wherein the injection device is at least partially filled with the medicinal injectable substance. Some embodiments include coupling the lid to the outer case such that the outer case and the lid surround the injection device.

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

Some of the embodiments and processes use computers. In some embodiments, a computer warns the user if a temperature, such as the temperature of the injectable substance, drug, and/or thermal bank, deviates outside of a temperature range.

The various features and processes described above may be used independently of one another, or may be combined in various ways. All possible combinations and subcombinations are intended to fall within the scope of this disclosure. In addition, certain method, event, state, or process blocks may be omitted in some implementations. The methods and processes described herein are also not limited to any particular sequence, and the blocks or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, act, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

I claim:

1. A storage device comprising:
a chamber configured to store an injection device;
a thermal bank, wherein the thermal bank has a heat capacity of at least 1,200 J/K; and
an insulated cover, wherein the thermal bank is located inside of the insulated cover and at least a portion of the chamber is located inside of the thermal bank.

2. The storage device of claim 1, wherein the injection device is located inside of the chamber.

3. The storage device of claim 2, wherein the injection device comprises a syringe and a pharmaceutical agent located inside of the syringe.

4. The storage device of claim 3, wherein the pharmaceutical agent comprises epinephrine.

5. The storage device of claim 1, wherein the thermal bank comprises a hole that extends to an outer surface of the thermal bank and at least a portion of the chamber is located in the hole.

6. The storage device of claim 1, wherein the chamber has a volume and at least 60% of the volume of the chamber is located inside the thermal bank.

7. The storage device of claim 1, wherein the storage device has a central axis and the chamber is located approximately along a portion the central axis, a portion of the thermal bank is located radially outward relative to the chamber, and a portion of the insulated cover is located radially outward relative to the thermal bank.

8. The storage device of claim 7, wherein the thermal bank is coupled to the insulated cover and the thermal bank is substantially a solid.

9. The storage device of claim 7, wherein the thermal bank is rigidly coupled to the insulated cover and the thermal bank comprises a container with solid outer walls and the container is at least partially filled with a liquid.

10. A storage device comprising:
an outer case;
a vacuum flask located inside the outer case;
a thermal bank located inside the vacuum flask, the thermal bank comprising a heat capacity of at least 400 J/K, the thermal bank further comprising a void that extends from an inner portion of the thermal bank to an outer portion of the thermal bank, wherein the void is at least 1 cm wide and 4 cm long;
an injectable substance located inside the void; and
a removable lid configured to allow a user to remove the injectable substance from the storage device.

11. The storage device of claim 10, wherein the storage device has a volumetric center and the volumetric center is located inside the void.

12. The storage device of claim 10, wherein the heat capacity of the thermal bank is at least 2,000 J/K and less than 12,000 J/K.

13. A method of storing a medicinal injectable substance, the method comprising:
obtaining an outer case and a lid;
obtaining a vacuum flask located inside the outer case;
obtaining a thermal bank with a heat capacity of at least 400 J/K, wherein the thermal bank is located inside the vacuum flask;
placing an injection device inside the vacuum flask, wherein the injection device is at least partially filled with the medicinal injectable substance; and
coupling the lid to the outer case such that the outer case and the lid surround the injection device.

14. The method of claim 13, wherein the injection device comprises a syringe at least partially filled with epinephrine.

15. The method of claim 13, further comprising placing the injection device inside at least a portion of the thermal bank.

16. The method of claim 13, further comprising forming the outer case around at least a portion of the vacuum flask.

17. The method of claim 13, further comprising maintaining the injectable substance within a temperature range of at least 50 degrees F. and less than 90 degrees F.

18. The method of claim 13, further comprising isolating the injectable substance from fluids located outside of the injection device.

19. The method of claim 13, further comprising placing the thermal bank in a first environment, wherein the first environment has a temperature greater than 65 degrees F. and less than 85 degrees F., removing the thermal bank from the first environment and transporting the thermal bank towards a second environment while the thermal bank has a temperature greater than 65 degrees F. and less than 85 degrees F., wherein the second environment has a temperature less than 65 degrees F. or greater than 85 degrees F., and moving the thermal bank from the second environment to a third environment before the temperature of the thermal bank falls below 65 degrees F. or rises above 85 degrees F., wherein the third environment has a temperature greater than 65 degrees F. and less than 85 degrees F.

20. The method of claim 19, wherein the second environment is located outdoors, the method does not comprise using electricity to alter the temperature of the thermal bank while the thermal bank is located in the second environment, and the heat capacity of the thermal bank is at least 800 J/K.
